(19) United States
(12) Patent Application Publication
(10) Pub. No.: US 2024/0198433 A1
(43) Pub. Date: Jun. 20, 2024

(54) MODULAR TOOL AND METHOD FOR EJECTING AN INSERT OF A MODULAR TOOL

(71) Applicant: Kennametal Inc., Latrobe, PA (US)

(72) Inventors: Bernhard Eckl, Schmidgaden (DE); Michael Schuffenhauer, Fuerth (DE); Berthold Zeug, Fuerth (DE)

(21) Appl. No.: 18/540,056

(22) Filed: Dec. 14, 2023

(30) Foreign Application Priority Data
Dec. 16, 2022 (DE) 1020222137787

(51) Int. Cl. B23B 27/16

(52) U.S. Cl. CPC B23B 27/1611

(57) ABSTRACT

The invention relates to a modular tool comprising a body and an insert for machining a workpiece, wherein the insert comprises a tenon for insertion into a receptacle of the body, wherein the body comprises an access hole, through which the tenon is accessible for an assembly tool, wherein the tenon comprises a profile portion, which, upon insertion of the assembly tool into the access hole, engages with a lateral surface of the assembly tool so that, by a rotation of the assembly tool, the insert can be ejected from the receptacle. Furthermore, a method for ejecting an insert of such a modular tool is specified.

### RELATED APPLICATION DATA

The present application claims priority under 35 U.S.C. § 119 to German Patent Application No. 1020222137787, filed on Dec. 16, 2022, which is incorporated by reference herein in its entirety.

### FIELD

The invention relates to a modular tool and a method for ejecting an insert of such a modular tool.

### BACKGROUND

A modular tool is configured in at least two pieces and typically comprises a body to be clamped into a tool mount of a machine tool and an insert that is in turn inserted into the body. The insert is then used for the actual machining of a workpiece.

The insert is replaceable in principle, and this is a significant advantage of a modular tool compared to a non-modular tool. However, in operation, i.e., during the machining of a workpiece, the insert must be seated as firmly and definedly in the body as possible in order to ensure correct machining. Accordingly, a removal of the insert can be difficult if, for example, it is clamped in the body.

A rotary cutting tool is described in DE 10 2013 102 901 A1, which comprises: an exchangeable cutting tip having a first threaded portion and a tool body having a second threaded portion which cooperatively engages with the first threaded portion, wherein the second threaded portion can be moved relative to the tool body in a manner that selectively couples the cutting tip to the tool body.

In light of this, the problem addressed by the invention is to simplify removal of the insert from the body in the case of a modular tool. A correspondingly improved modular tool as well as a corresponding method for ejecting an insert are to be specified for this purpose.

### SUMMARY

The problem is solved according to the invention by a modular tool having the features according to claim 1 and by a method having the features according to claim 12. Advantageous configurations, further developments, and variants are the subject matter of the subclaims. The statements made in connection with the modular tool also apply to the method and vice versa.

A core concept of the invention is in particular to configure the use of a modular tool such that it can be ejected using a simple and preferably standardized assembly tool, e.g., a screwdriver.

A modular tool according to the invention comprises a body and an insert. The body serves in particular to assemble the modular tool in a tool mount, e.g., a chuck, of a machine tool. The insert serves to machine a workpiece. The insert is in particular a cutting insert for machining a workpiece. During the machining, the insert and the body are fixedly connected to one another. However, the insert is generally releasable in order to be replaced with a new insert, e.g., in the event of wear.

The modular tool generally extends along a longitudinal axis in a longitudinal direction. Preferably, the modular tool is a rotary tool that is rotatable about an axis of rotation for machining a workpiece. In other words, the longitudinal axis is also an axis of rotation about which the modular tool rotates while in operation. Such a design is assumed below without limiting its generality.

Particularly preferred is a configuration in which the modular tool is a drill having one or more main cutting edges formed on the insert. In a suitable embodiment, the insert is a so-called cutting plate, i.e., is plate-shaped with two cutting edges.

The insert comprises a tenon for insertion into a receptacle of the body. The tenon preferably extends along the axis of rotation, i.e., in the axial direction. To machine the workpiece, the insert also comprises in particular a head, to which the tenon connects, in particular in the longitudinal direction. Preferably, especially in the case of a rotary tool, the tenon extends along the longitudinal axis, i.e., in particular concentrically to the body. The same applies analogously for the receptacle. The tenon and the receptacle are preferably generally cylindrical. In the assembled state, the tenon is seated in the receptacle and the insert is attached to the body. The head has a length preferably corresponding to 0.5-fold to 2-fold of a length of the tenon. Typically, the head and the tenon are approximately the same length.

The body comprises an access hole, through which the tenon is accessible for an assembly tool. The access hole extends preferably transversely to the axis of rotation, i.e., in a radial direction. The assembly tool is, for example, a screwdriver. The assembly tool can be actuated manually or by a robot. The tenon is generally inserted into the body and then surrounded and in particular also obscured by it. The access hole now represents an opening in the body through which the tenon is nevertheless accessible, at least for the assembly tool. Suitably, the body has a lateral surface, which extends in particular around the longitudinal axis, and the access hole lies in the lateral surface of the body. The access hole is suitably a blind hole, but this is not mandatory, and a through-hole is also generally suitable. In one suitable design, the access hole passes by the tenon, but in another suitable design, the access hole leads onto the tenon. The access hole is suitably circular, but a round hole is also generally suitable.

The tenon comprises a profile portion, which, upon insertion of the assembly tool into the access hole, engages with a lateral surface of the assembly tool so that, by a rotation of the assembly tool, the insert can be ejected from the receptacle, in particular on the front side, i.e., forward in the longitudinal direction. In other words: to eject the insert, the assembly tool is inserted into the access hole so that the lateral surface of the assembly tool then engages with the profile portion of the tenon and thus, by subsequently rotating the assembly tool, the insert is ejected from the receptacle. The access hole itself serves in particular as a counter-bearing against which the assembly tool is supported during a rotation, so that the tenon and correspondingly the entire insert are moved relative thereto, in particular in the longitudinal direction.

The profile portion is a core aspect of the present invention and advantageously allows the ejection of the insert with a simple assembly tool. The profile portion is arranged laterally on the tenon, i.e., on a lateral surface of the tenon, and is accessible for the assembly tool via the access hole. The profile portion is preferably shaped complementary to the lateral surface of the assembly tool in order to ensure as optimum an engagement as possible. When the assembly tool is inserted into the access hole, the lateral surface of the assembly tool extends in particular from the side into the profile portion.

The specific configuration of the lateral surface of the assembly tool is dependent in particular upon the configuration of the latter. With a screwdriver as the assembly tool, the latter comprises a tip, which is configured so as to engage with a tool engagement portion of a screw head. In the present case, a screwdriver is assumed to be the assembly tool, without limiting its generality. Depending on the front profile (also cross-section) and the circumferential contour (also tool contour) of the tip, varying lateral surfaces of the assembly tool may then result. However, the lateral surface is generally characterized by a plurality of edges and/or ribs, which are particularly suitable for engaging with the profile portion.

Preferably, the assembly tool has an at least four-fold rotational symmetry, in particular with respect to its front profile and then consequently also with respect to its lateral surface. Accordingly, the lateral surface of the assembly tool has at least four edges. This is the case, for example, with a Phillips screwdriver. Particularly preferred is an assembly tool having a six-fold rotational symmetry, e.g., a hexagonal or six-lobe screwdriver having a lateral surface with six edges/ribs.

The invention in particular makes use of the finding that an assembly tool can be used not only with its front profile, but the front profile also leads to a gear-like lateral surface equipped with edges or ribs. This is advantageously used in the manner of a gear for engaging with a correspondingly configured profile portion of the tenon in order to ultimately drive it, i.e., move it linearly. In this way, a tool-assisted ejection of the insert is realized, which in turn makes it particularly easy to remove a possibly clamped or even jammed insert from the body in a simple manner. In this way, an exchange of the insert is also accordingly simplified. Above all, it is now not necessary to remove the modular tool in order to eject the insert from the tool mount, i.e., an exchange of the insert can be performed while the modular tool is mounted in the tool mount.

Particularly preferred is a configuration in which, due to the profile portion, the tenon is formed in the manner of a rack in order to form, together with the assembly tool, a rack drive for ejecting the insert. The assembly tool, specifically its tip, forms a gear with which the tenon is driven. Accordingly, the profile portion comprises a plurality of teeth and grooves, which are preferably parallel to one another, for engaging with the assembly tool, more precisely with the lateral surface thereof. The grooves and teeth either run perpendicular to the tenon overall or at a non-perpendicular angle thereto. During the retraction, the edges/ribs of the lateral surface of the assembly tool laterally retract into the grooves, i.e., the assembly tool is not mounted on the profile portion from above, so to speak, but instead gradually extends perpendicularly or at a non-perpendicular angle into the profile portion, as it were. Because this assembly tool is supported in the access hole during the rotation, the tenon is driven out of the receptacle accordingly. Suitably, the profile portion comprises at least 2 grooves and/or at most 10 grooves. The exact number of grooves will depend in particular on the size of the insert and the assembly tool as well as the required displacement path for the insert.

Preferably, the insert can be inserted into the body on the front side, and the body comprises for this purpose a seat on the front side with two arms between which the insert is held. Here, “front side” is understood to mean “facing the workpiece.” When assembled, the insert is inserted into the body and received by the seat and is encompassed by the arms. The seat is in particular U-shaped in a cross-section along the longitudinal axis, wherein the two arms form the two legs of the U and a base of the seat forms the base of the U connecting the arms together. The receptacle for the tenon is arranged in the base, in particular. The arms are preferably formed with an interference fit, so that the insert is firmly clamped between the arms.

Expediently, the modular tool comprises a releasable clamping mechanism for firmly clamping the insert. The clamping mechanism suitably comprises a clamping element, preferably a clamping screw, which is inserted into the body and engages with the tenon for firm clamping. Accordingly, the clamping mechanism is arranged overall in particular in a front-side half of the modular tool. For the clamping element, the tenon suitably comprises a recess into which the clamping element engages for the purpose of clamping. Expediently, the clamping mechanism is even configured such that it pulls the insert into the seat upon actuation. In this way, any resistance (e.g., due to the aforementioned interference fit) is overcome without having to push on the insert on the front side. In a suitable configuration, the clamping element is inserted obliquely (e.g., at an angle of 20° to 70° to the longitudinal axis) into the body, and the tenon has a corresponding slope on its lateral surface against which the clamping element presses when actuated in order to clamp the insert. In this way, an axial force can be generated via an access proceeding from the lateral surface of the body in order to firmly clamp the insert in the longitudinal direction. The slope is suitably formed by the aforementioned recess, which, for example, is trapezoidal when viewed in a cross-section along the longitudinal axis. For example, the recess is a simple groove.

The profile portion is preferably arranged between the head of the insert and the recess for the clamping element. In particular, this avoids the clamping mechanism being too close to the tip of the modular tool.

The clamping element can generally be actuated by an assembly tool, in particular also by a rotation of the assembly tool, which is, for example, a screwdriver. In a particularly advantageous design, the clamping element can be actuated by the assembly tool, with which the insert is also ejected. Accordingly, a similar or even the same assembly tool can advantageously be used in two ways, namely once for actuating the clamping mechanism and once for ejecting the insert.

In an advantageous configuration, the modular tool is configured such that the clamping element is automatically actuated by the assembly tool and thereby the clamping mechanism is released when the assembly tool is inserted into the access hole. With its front profile, the assembly tool abuts the clamping element in particular at the end of the access hole, which is thereby pushed out of the tenon and generally radially outward and releases the tenon for a movement in the longitudinal direction. The clamping element is expediently spring-loaded, in the present case by means of a spring, so that the assembly tool is operated against the spring. Subsequently, the insert is then ejected by a rotation of the assembly tool. Subsequently, a new insert can be introduced. As the assembly tool is removed from the access hole, the clamping element is then automatically retracted back into the tenon, if provided.

The tenon of the insert has a two-fold rotational symmetry, i.e., it is rotatable about the longitudinal axis by 180° and can be inserted into the body in two orientations. This is particularly advantageous with correspondingly symmetrical cutting plates, whose orientation cannot be readily be viewed. Due to the rotational symmetry, regardless of how the insert is used, an ejection and in particular firm clamping is possible in both orientations, even if the body only comprises a single access hole and optionally a single clamping element. Preferably, the insert as a whole (and in particular also the seat for it) has a two-fold rotational symmetry.

In a suitable configuration, the receptacle for the tenon is an end portion of a media channel of the body, i.e., a channel for a coolant and/or lubricant. The tenon then closes the media channel on the front side. In particular, the body comprises one or more lateral media outlets, which are connected to the media channel. The media channel extends through the body in the longitudinal direction and preferably along the longitudinal axis. A medium is input into the media channel in particular on the rear side of the body. One particular advantage of the ejection described herein is that the media channel no longer has to be used in order to also introduce an assembly tool for ejecting the insert, rather it is free of this and can thus be designed solely depending on the requirements of a media guidance. This results from the profile portion and the arrangement of the access hole and also applies wholly irrespective of whether the receptacle for the insert is part of the media channel.

In addition to ejecting the insert, the tenon with the profile portion and the assembly tool can advantageously be used inversely for the retraction of the insert into the body by simply rotating the assembly tool in the reverse direction.

The problem is also solved in particular by the combination of a modular tool and an assembly tool as described, as well as separately from one another by an insert and a body of a modular tool as described.

### DESCRIPTION OF THE DRAWINGS

Exemplary embodiments of the invention are explained in more detail in the following with the aid of a drawing. The figures show schematically:

FIG. 1a a modular tool and an assembly tool in a side view,

FIG. 1b a different representation of the modular tool in the view from FIG. 1a,

FIG. 1c the modular tool from FIG. 1a in a slightly rotated view,

FIG. 2 the modular tool and the assembly tool from FIG. 1a in a perspective view,

FIG. 3 the modular tool from FIG. 1a in a front view,

FIG. 4 the modular tool from FIG. 1a in the section A-A according to FIG. 3,

FIG. 5 the modular tool from FIG. 1a in the section B-B according to FIG. 3,

FIG. 6 a partial view of the modular tool from FIG. 1a in the section B-B according to FIG. 3,

FIG. 7 a cutout of the modular tool from FIG. 1a in a side view,

FIG. 8 a detail view of the modular tool from FIG. 1 in a perspective view,

FIG. 9 an insert of the modular tool from FIG. 1a in three different views.

### DETAILED DESCRIPTION

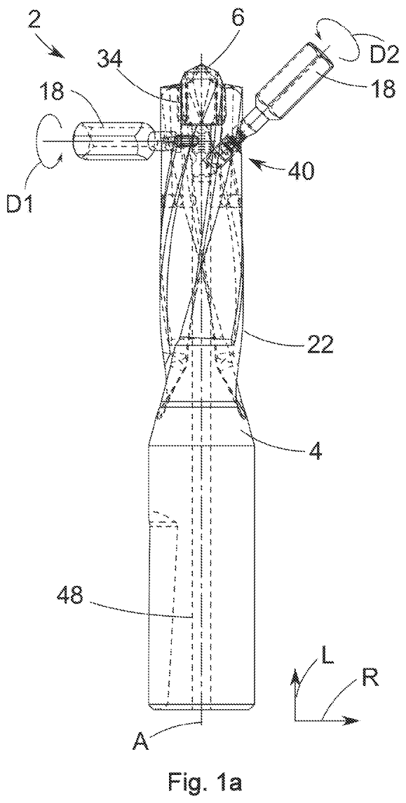

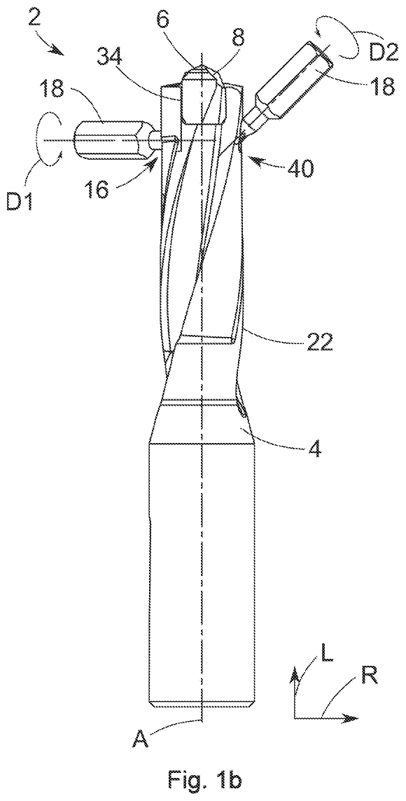

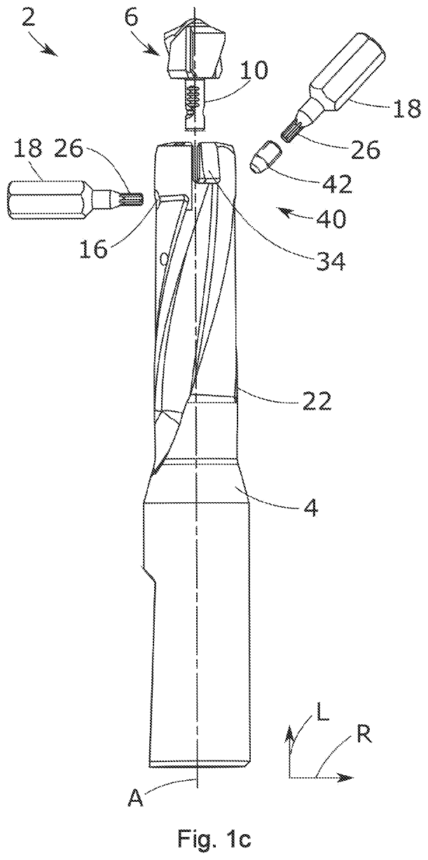

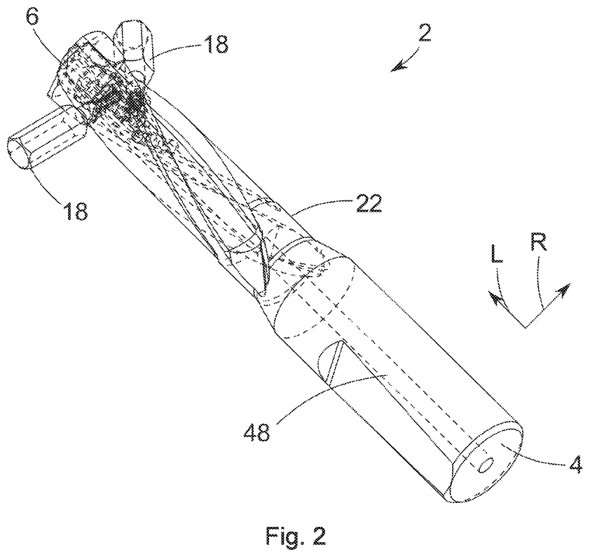

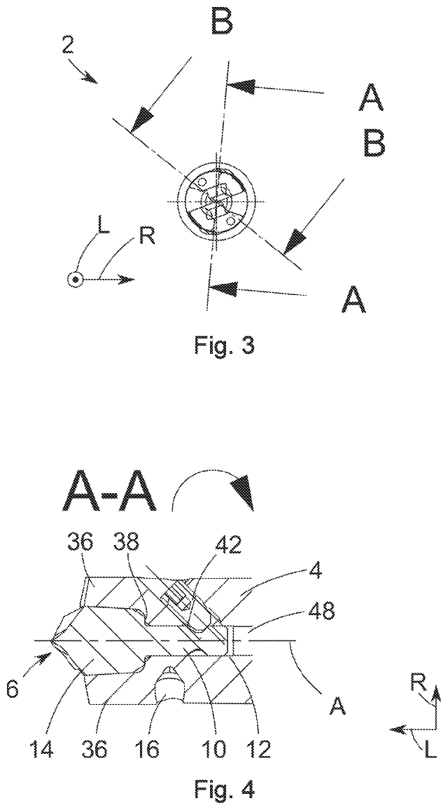

In FIGS. 1a, 1b, and 1c, a modular tool 2 is shown in a side view. FIG. 1a shows the modular tool 2 in a transparent view, and FIG. 1b shows the same view but not transparent. FIG. 1c shows an exploded view of the modular tool 2, and the view is slightly rotated about the longitudinal axis A compared to FIGS. 1a and 1b. FIG. 2 shows the same modular tool in a perspective view.

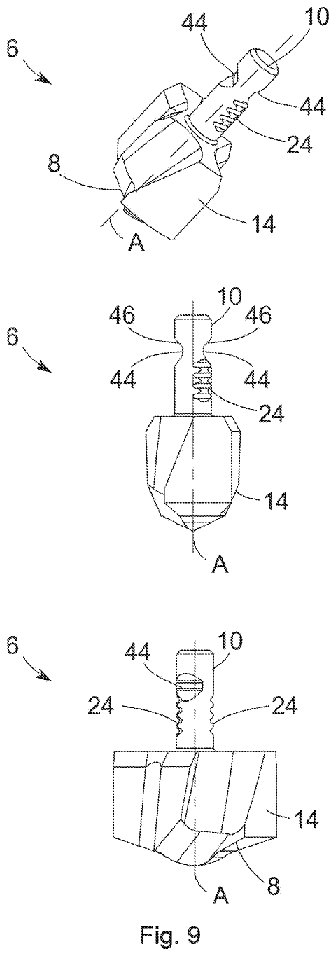

The modular tool 2 comprises a body 4 and an insert 6. The body 4 serves for assembly of the modular tool 2 in a tool mount (not shown) on a tool machine (also not shown). The insert 6 serves for machining a workpiece (not shown), and in the present case is a cutting insert. During the machining, the insert 6 and the body 4 are fixedly connected to one another. However, the insert 6 is generally releasable. An exemplary embodiment for the insert 6 is shown in FIG. 9 in three different views.

The modular tool 2 generally extends along a longitudinal axis A in a longitudinal direction L. The modular tool 2 shown by way of example here is a rotary tool, in which the longitudinal axis A is simultaneously an axis of rotation. In addition, the modular tool 2 shown by way of example here is a drill having one or more (here two) main cutting edges 8, which are formed on the insert 6. More specifically, the insert 6 shown here is a so-called cutting plate.

The insert 6 comprises a tenon 10 for insertion into a receptacle 12 of the body 4. To machine the workpiece, the insert 6 comprises a head 14, to which the tenon 10 connects in the longitudinal direction L. The tenon 10 extends along the longitudinal axis L and concentrically to the body 4. The same applies analogously for the receptacle 12. The tenon 10 and the receptacle 12 are generally cylindrical. In the assembled state, the tenon 10 is seated in the receptacle 12 and the insert 6 is attached to the body 4. In the present case, the head 14 and the tenon 10 are approximately the same length.

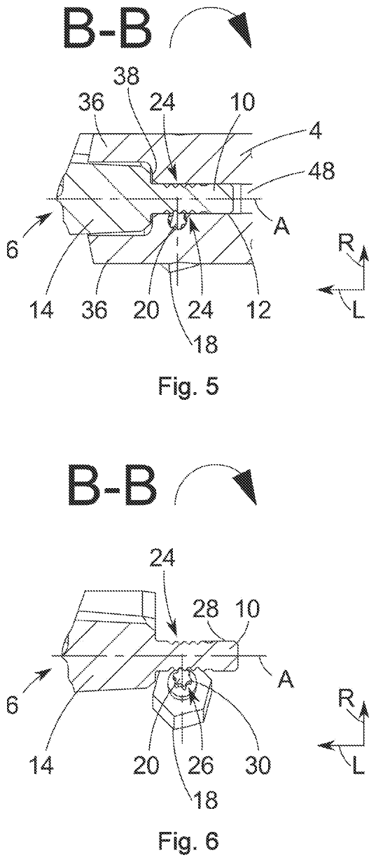

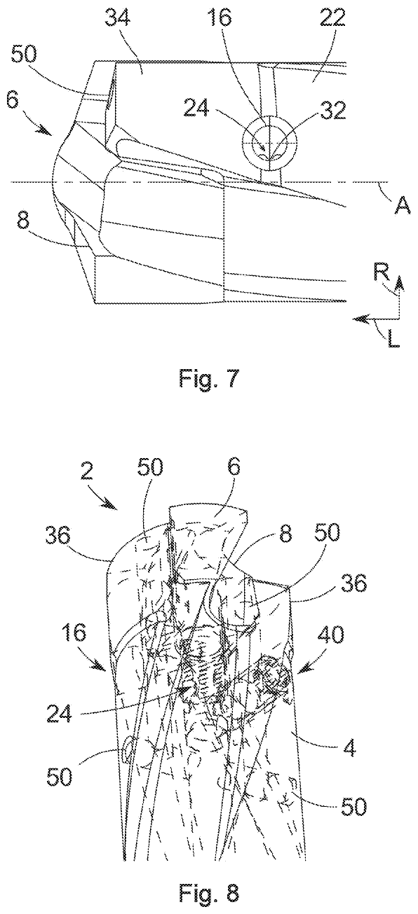

The body 4 has an access hole 16 through which the tenon 10 is accessible for an assembly tool 18, for which an exemplary embodiment is shown in FIGS. 1a, 1b, 1c and which is also visible in FIGS. 2, 5, and 6. In FIGS. 1a to 2, the assembly tool 18 is shown in duplicate, because the same assembly tool 18 is used for two different tasks, as will be explained further below. The access hole 16 runs transversely to the axis of rotation, i.e., in the radial direction R. In the present case, the assembly tool 18 is a screwdriver, more specifically a six-lobe screwdriver. The assembly tool 18 can be actuated manually or by a robot. The tenon 10 is generally inserted into the body 4 and then surrounded and also obscured by it. The access hole 16 now represents an opening in the body 4 through which the tenon 10 is nevertheless accessible, at least for the assembly tool 18. This can be seen particularly clearly in FIGS. 5, 6, and 7. The access hole 16 and a front profile 20 of the assembly tool 18 as well as their position relative to the tenon 10 can also be seen. The access hole 16 lies in the lateral surface 22 of the body 4. The access hole 16 shown here is a blind hole, but this is not mandatory. In addition, the access hole 16 shown here passes by the tenon 10, but this is also not mandatory.

The tenon 10 comprises a profile portion 24, which, upon insertion of the assembly tool 18 into the access hole 16, engages with a lateral surface 26 of the assembly tool 18 so that, by a rotation D1 of the assembly tool 18, the insert 6 can be ejected from the receptacle 12. In other words: to eject the insert 6, the assembly tool 18 is inserted into the access hole 16 so that the lateral surface 26 of the assembly tool 18 then engages with the profile portion 24 of the tenon 10 and thus, by subsequently rotating the assembly tool 18, the insert 6 is ejected from the receptacle 12. The access hole 16 itself serves as a counter-bearing against which the assembly tool 18 is supported during a rotation D1 (cf. FIG. 5), so that the tenon 10 and correspondingly the entire insert 6 are moved relative thereto, namely in the longitudinal direction L.

The profile portion 24 is shaped complementary to the lateral surface 26 of the assembly tool 18 and allows the ejection of the insert 6 with a simple assembly tool 18. The profile portion 24 is arranged laterally on the tenon 10, i.e., on a lateral surface 28 of the tenon 10, and is accessible for the assembly tool 18 via the access hole 16.

The specific configuration of the lateral surface 26 of the assembly tool 18 is dependent upon the configuration of the latter. In the screwdriver shown here, the assembly tool 18 comprises a tip, which is configured so as to engage with a tool engagement portion of a screw head. Depending on the front profile 20 and circumferential contour of the tip, varying lateral surfaces 26 of the assembly tool 18 may then result. However, the lateral surface 26 is generally characterized by a plurality of edges and/or ribs 30, which are particularly suitable for engaging with the profile portion 24.

The assembly tool 18 has an at least four-fold, even six-fold rotational symmetry with respect to its front profile 20 and then consequently also with respect to its lateral surface 26. Accordingly, the lateral surface 26 of the assembly tool 18 has at least four, here six edges 30.

As can be seen in particular in FIGS. 5, 6, and 9, in the configuration shown here, due to the profile portion 24, the tenon 10 is formed in the manner of a rack in order to form, together with the assembly tool 18, a rack drive for ejecting the insert 6. The assembly tool 18, specifically its tip, forms a gear with which the tenon 10 is driven. The profile portion 24 correspondingly comprises a plurality of teeth and grooves 32 parallel to one another for engaging with the lateral surface 26 of the assembly tool 18. Because it is supported in the access hole 16 during the rotation D1, the tenon 10 is driven out of the receptacle 12 accordingly. The profile portion 24 shown here comprises four grooves 32, but other numbers are also possible.

The insert 6 can be inserted into the body 4 on the front side, and the body 4 comprises for this purpose a seat 34 on the front side with two arms 36 between which the insert 6 is held. Here, “front side” is understood to mean “facing the workpiece.” When assembled, the insert 6 is inserted into the body 4 and received by the seat 6 and is encompassed by the arms 36. The seat 34 is U-shaped in a cross-section along the longitudinal axis A, wherein the two arms 36 form the two legs of the U and a base 38 of the seat 34 forms the base of the U connecting the arms 34 together. The receptacle 12 for the tenon 10 is arranged in the base 38. In the present case, the arms 34 are formed with an interference fit, so that the insert 6 is firmly clamped between the arms 34.

The modular tool 2 shown here further comprises a releasable clamping mechanism 40 for firmly clamping the insert 6. The clamping mechanism 40 comprises a clamping element 42, here a clamping screw (recognizable in FIG. 4), which is inserted into the body 4 and engages with the tenon 10 for the purpose of firm clamping. The clamping mechanism 40 is arranged overall in a front-side half of the modular tool 2. For the clamping element 42, the tenon 10 comprises a recess 44 into which the clamping element 42 engages for the purpose of clamping. The clamping mechanism 40 shown here is even configured such that it pulls the insert 6 into the seat 34 upon actuation. The clamping element 42 is also inserted obliquely into the body 4, and the tenon 10 has a corresponding slope 46 on its lateral surface 28 against which the clamping element 42 presses when actuated in order to firmly clamp the insert 6. In this way, an axial force can be generated via an access proceeding from the lateral surface 22 of the body 4 in order to firmly clamp the insert 6 in the longitudinal direction L. In the present case, the slope 46 is formed by the aforementioned recess 44, which in the present case is a trapezoidal groove when viewed in a cross-section along the longitudinal axis A. In the present case, between the recess 44 and the head 14, the profile portion 24 is arranged.

The clamping element 42 can generally be actuated by an assembly tool 18, in the present case also by a rotation D2 of the assembly tool 18, which has already been described. Thus, in the present case, a similar or even the same assembly tool 18 can be used in two ways, namely once for actuating the clamping mechanism 40 and once for ejecting the insert 6.

The insert 6, and in particular the tenon 10, have a two-fold rotational symmetry in the exemplary embodiment shown, i.e., it can be rotated by 180° about the longitudinal axis A and can be inserted into the body 4 in two orientations.

The receptacle 12 for the tenon 10 in the configuration shown here is an end portion of a media channel 48 of the body 4, i.e., a channel for a coolant and/or lubricant. The tenon 10 then closes the media channel 48 on the front side. The body 4 here comprises one or more lateral media outlets 50, which are connected to the media channel 48. The media channel 48 extends through the body 4 in the longitudinal direction L and along the longitudinal axis A. A medium is input into the media channel 48 on the rear side of the body 4.

In addition to ejecting the insert 6, the tenon 10 with the profile portion 24 and the assembly tool 18 can be used inversely for the retraction of the insert 6 into the body 4 by simply rotating the assembly tool in the reverse direction.

In an alternative configuration, not explicitly shown, the modular tool 2 is configured such that the clamping element 42 is automatically actuated by the assembly tool 18 and thereby the clamping mechanism 40 is released when the assembly tool 18 is inserted into the access hole 16. With its front profile 20, the assembly tool abuts the clamping element 42 at the end of the access hole 16, which is thereby pushed out of the tenon 10 and generally radially outward and releases the tenon 10 for a movement in the longitudinal direction L. The clamping element 42 is spring-loaded, for example by means of a spring, so that the assembly tool 18 is operated against the spring. The insert 6 is subsequently ejected by a rotation D1 of the assembly tool 18. Subsequently, a new insert 6 can be introduced. As the assembly tool 18 is removed from the access hole 16, the clamping element 42 is then automatically retracted back into the tenon 10.

1. A modular tool comprising a body and an insert for machining a workpiece, wherein:
the insert comprises a tenon for insertion into a receptacle of the body;
the body comprises an access hole, through which the tenon is accessible for an assembly tool; and
the tenon comprises a profile portion, which, upon insertion of the assembly tool into the access hole, engages with a lateral surface of the assembly tool so that, by a rotation of the assembly tool, the insert can be ejected from the receptacle.

2. The modular tool according to claim 1, wherein, due to the profile portion, the tenon is configured in the manner of a rack in order to form, together with the assembly tool, a rack drive for ejecting the insert.

3. The modular tool according to claim 1, wherein:
it is a rotary tool that is rotatable about an axis of rotation for machining a workpiece;
the tenon extends along the axis of rotation; and
the access hole runs transversely to the axis of rotation.

4. The modular tool according to claim 1, wherein it is a drill having one or more main cutting edges formed on the insert.

5. The modular tool according to claim 1, wherein the insert can be inserted into the body on the front side, and the body comprises for this purpose a seat on the front side with two arms between which the insert is held.

6. The modular tool according to claim 1, wherein:
it comprises a releasable clamping mechanism for firmly clamping the insert; and
the clamping mechanism comprises a clamping element, which is inserted into the body and engages with the tenon for the purpose of firm clamping.

7. The modular tool according to claim 6, wherein the profile portion is arranged between a head of the insert and a recess for the clamping element.

8. The modular tool according to claim 6, wherein the clamping element can be actuated by the assembly tool.

9. The modular tool according to claim 6, wherein it is configured such that the clamping element is automatically actuated by the assembly tool, thereby releasing the clamping mechanism when the assembly tool is inserted into the access hole.

10. The modular tool according to claim 1, wherein the tenon of the insert has a two-fold rotational symmetry.

11. The modular tool according to claim 1, wherein the receptacle is an end portion of a media channel of the body.

12. A method for ejecting an insert of a modular tool according to claim 1, wherein:
the assembly tool is inserted into the access hole so that the lateral surface of the assembly tool then engages with the profile portion; and
the assembly tool is subsequently rotated, thereby ejecting the insert out of the receptacle.

13. The method according to claim 12, wherein the assembly tool has an at least four-fold rotational symmetry.

14. The modular tool according to claim 2, wherein:
it is a rotary tool that is rotatable about an axis of rotation for machining a workpiece;
the tenon extends along the axis of rotation; and
the access hole runs transversely to the axis of rotation.

15. The modular tool according to claim 2, wherein it is a drill having one or more main cutting edges formed on the insert.

16. The modular tool according to claim 3, wherein it is a drill having one or more
main cutting edges formed on the insert.

17. The modular tool according to claim 2, wherein the insert can be inserted into
the body on the front side, and the body comprises for this purpose a seat on the front side with two arms between which the insert is held.

18. The modular tool according to claim 3, wherein the insert can be inserted into
the body on the front side, and the body comprises for this purpose a seat on the front side with two arms between which the insert is held.

19. The modular tool according to claim 4, wherein the insert can be inserted into
the body on the front side, and the body comprises for this purpose a seat on the front side with two arms between which the insert is held.

20. The modular tool according to claim 2, wherein:
it comprises a releasable clamping mechanism for firmly clamping the insert; and
the clamping mechanism comprises a clamping element, which is inserted into the body and engages with the tenon for the purpose of firm clamping.
